(19) United States
(12) Patent Application Publication
(10) Pub. No.: US 2011/0274944 A1
(43) Pub. Date: Nov. 10, 2011

(54) Polymeric Article Having A Surface Of Different Composition Than Its Bulk And Of Increased Bonding Strength To A Coated Metal Layer

(76) Inventor: Andri Elia Elia, Chadds Ford, PA (US)

(21) Appl. No.: 12/776,945

(22) Filed: May 10, 2010

(51) Int. Cl. B32B 27/34; B29C 45/00; B32B 15/088; C08G 69/08; C08K 3/26

(52) U.S. Cl. 428/626; 528/310; 428/336; 428/409; 525/50; 524/425; 428/458; 264/328.1

(57) ABSTRACT

The present invention provides articles comprised of a single resin system that has a surface and a core of different compositions, the surface having more extractable component and less fillers than the core. This arrangement provides for increased peel strength in articles formed from or including such articles. The present invention also provides methods of making the articles.

### FIELD OF THE INVENTION

The disclosed invention is in the field of thermoplastic compositions particularly suitable for metal plated articles and a process for creating a surface of the thermoplastic compositions that results in stronger polymer to metal bond.

### BACKGROUND OF THE INVENTION

Coating thermoplastic polymers (TPs) with metals is well known in the art. Metal coated TPs are utilized for numerous aesthetic purposes, such as chrome plating shower heads and automotive door handles. In addition, TPs provide improved functional performance in areas such as electromagnetic shielding. The metal may be coated onto the TP using a variety of methods, such as electrolysis or electroplating, vacuum metallization, different sputtering methods, lamination of metal foil onto the thermoplastic, or other commonly used methods.

Metal coating is most commonly carried out by surface treating and then “activating” the surface of the TP with a catalyst so that it may be electrolessly plated, and, optionally, coating the majority of the metal electrolytically. The surface treatment of the TP may involve mechanical and/or chemical “etching” of the surface, so as to allow electroless plating and/or allow and improve the adhesion of the metal layer to the TP surface. A typical method of treating the TP surface is to use a solution containing sulfuric and chromic (chromium VI) acids, which is often used to surface treat or etch TPs such as ABS, polyamides and other TPs, including partially aromatic polyamides (PAPs).

The TP itself may determine the specific surface treatment needed. For instance, aliphatic polyamides, such as polyamide-6,6 and polyamide-6 may be treated by a variety of methods. However, PAPs, in which most or all of the dicarboxylic acid used to form the polyamide is an aromatic dicarboxylic acid, are often more resistant to chemical surface treatment.

Adhesion strength between the polymer and the metal is important so that the article can withstand prolonged performance without separation. Typical methods of improving the adhesion strength are known to include extractables. It is also known that the presence of reinforcing fibers can weaken the adhesion bond. It is therefore beneficial to prepare an article of a single resin that has more extractables and less reinforcing fibers on the surface.

Generally speaking, the metal coating should have sufficient adhesion so that it does not separate from the thermoplastic substrate during use. In the traditional aesthetic or functional applications, this is not generally an issue, and reasonably moderate levels of adhesion are sufficient. However, in the case of structural applications, this may be particularly difficult if the product must undergo temperature cycling, which is repeated heating and cooling above and/or below ambient temperature. Since most thermoplastic compositions have different thermal coefficients of expansion than most metals, the repeated heating and cooling cycles may stress the interface between the metal and TP, resulting in weakening the interface between the TP and metal coating, and eventually in separation of the metal from the TP. Therefore, methods and/or compositions for improving the adhesion of TPs to metal coatings are desired.

### SUMMARY OF THE INVENTION

The present invention provides polymeric articles having at least one surface region and comprising thermoplastic polymer, an extractable component, and optionally, fillers. The surface region of the polymeric articles is relatively enhanced in extractable component and relatively depleted in fillers as compared to the articles as a whole.

The present invention also provides a method of making polymeric articles having at least one surface region and comprising thermoplastic polymer, an extractable component, and, optionally, fillers, the surface region being relatively enhanced in extractable component and relatively depleted in fillers as compared to the articles as a whole. The method comprises: (a) melting the thermoplastic polymer and blending it with extractable component and fillers; and (b) injection molding the polymeric article at a melt temperature at least about 20° C. above the melting point of the thermoplastic polymer and a mold temperature at least 200° C. below the melt temperature or less than about 20° C. above the glass transition temperature of the thermoplastic polymer.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE FIGURES

The summary, as well as the following detailed description, is further understood when read in conjunction with the appended figures. For the purpose of illustrating the invention, there are shown in the figures exemplary embodiments of the invention. However, the invention is not limited to the specific methods, compositions, and devices disclosed. In addition, the figures are not necessarily drawn to scale. In the figures:

FIG. 1 depicts the comparison between a molded composition with fewer anchoring sites after etching, which yield non-homogeneous adhesion to the metal coating, as compared to a molded composition with an increased number of anchoring sites after etching, thereby resulting in homogeneous adhesion to the metal coating and increased peel strength

FIG. 2 depicts the increase in peel strength with more extractable components on the surface of a molded composition before the etching process.

FIG. 3 depicts the increase in peel strength on the surface of a molded composition with larger anchoring sites after the etching process.

FIG. 4 depicts the increase in peel strength on the surface of a molded composition after the etching process with less glass on the surface.

FIG. 5a depicts an embodiment of a portion of an article in accordance with the invention.

FIG. 5b depicts an embodiment of the core and surface portion of an article in accordance with the invention, showing a surface that is relatively depleted in reinforcing fibers and relatively enhanced in extractable component.

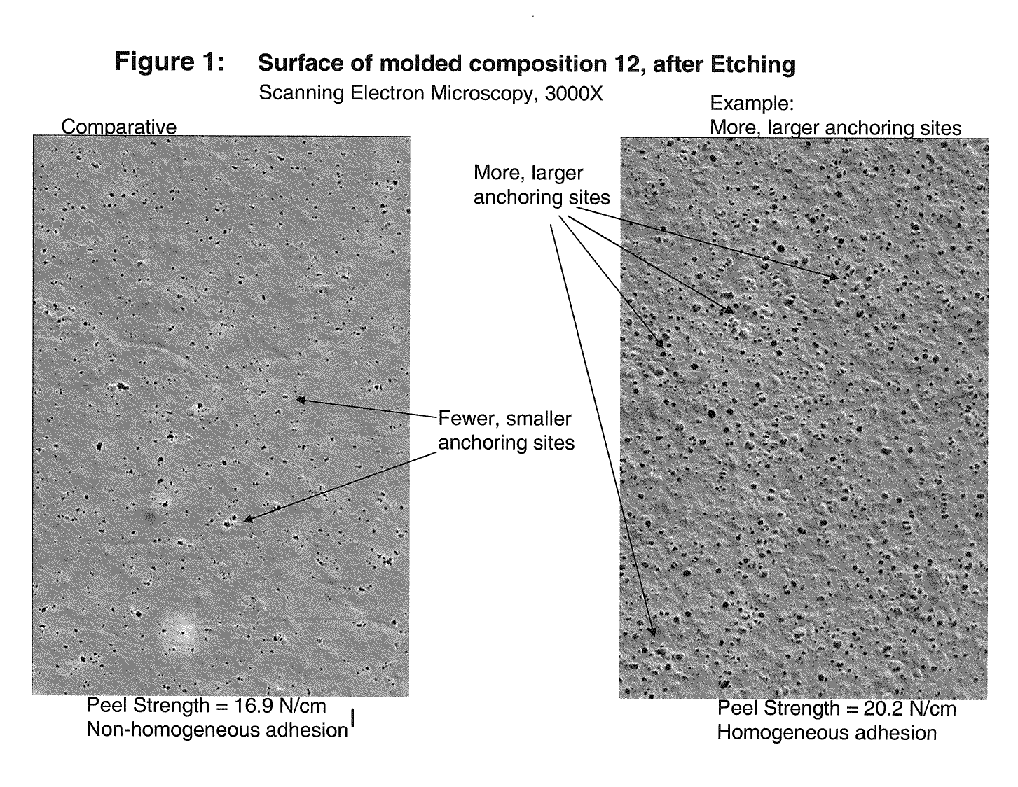

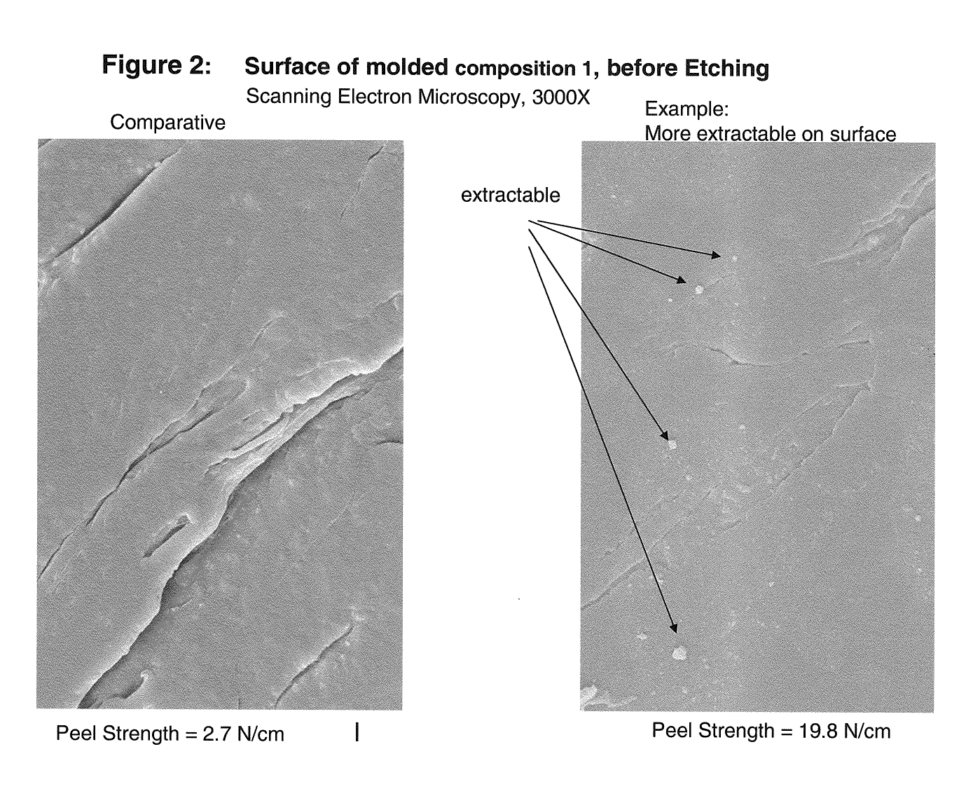

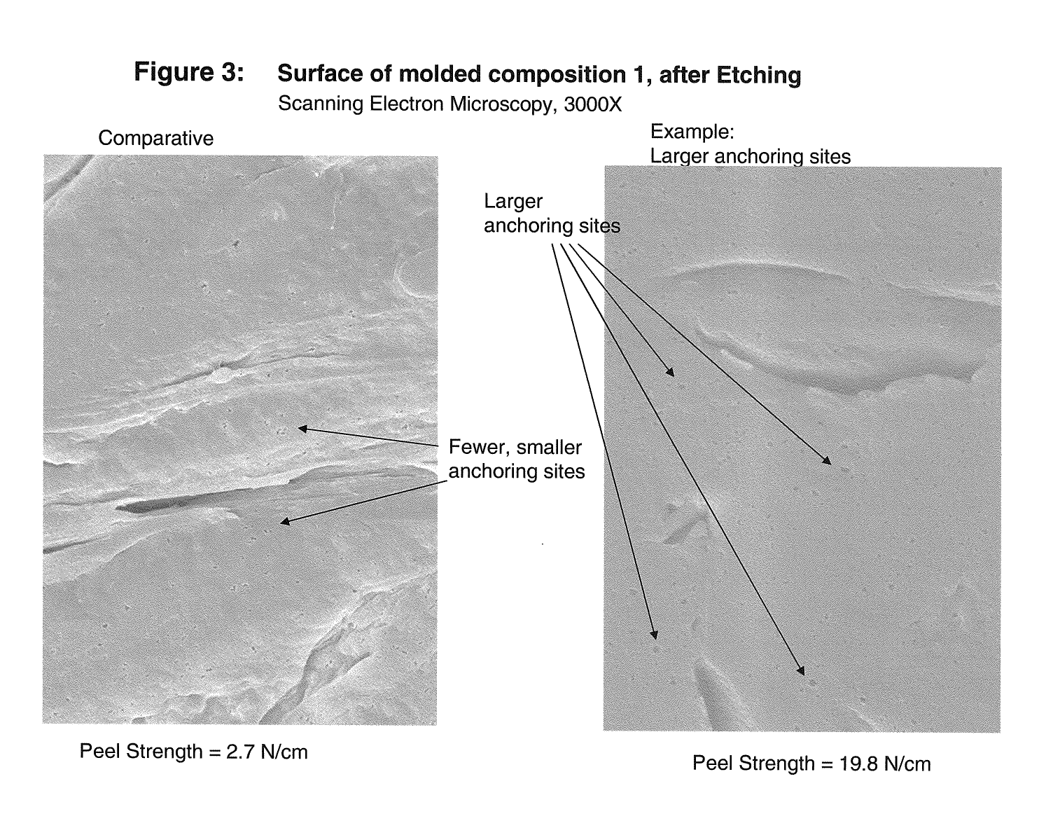

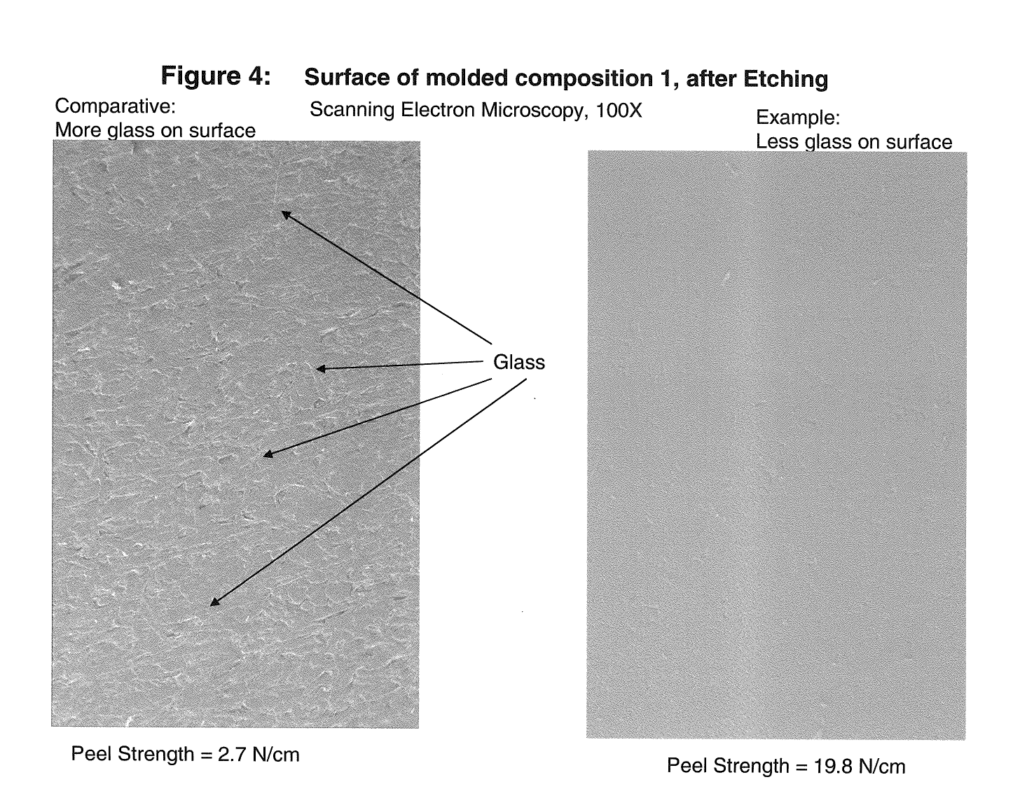

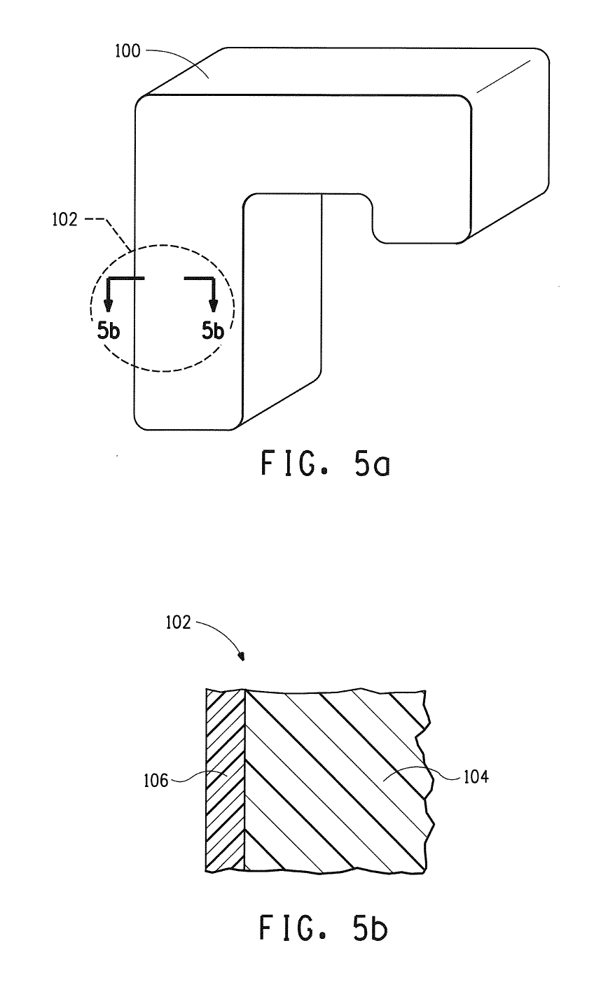

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions, or parameters described and/or shown herein, and that the terminology used herein is for the purpose of describing particular embodiments by way of example only and is not intended to be limiting of the claimed invention. Also, as used in the specification including the appended claims, the singular “a”, “an”, and “the” include the plural, and reference to a particular numerical value includes at least that particular value, unless the context clearly dictates otherwise. When a range of values is expressed, another embodiment includes from the one particular value and/or to the particular value. Similarly, when values are expressed as approximations, by use of the antecedent “about”, it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any sub-combination. Further, reference to values stated in ranges includes each and every value within that range.

As used herein, the term “thermoplastic polymer” (“TP”) indicates an organic polymeric material that is not crosslinked and which has a glass transition temperature (Tg) and/or melting point (Tm) above 30° C. Tm and Tg are measured using ASTM Method D3418-82, using a second heat. Measurements are made on the second heat. The Tm is taken as the peak of the melting endotherm, while the Tg is taken as the inflection point of the glass transition. To be considered a Tm, the heat of melting for any melting point should be at least about 1.0 J/g.

As used herein, the term “semicrystalline thermoplastic polymer” is a thermoplastic which has a melting point above 30° C. with a heat of melting of at least about 2.0 J/g, more preferably at least about 5.0 J/g.

As used herein, “polyamides” are defined conventionally as composed of a mixture of polyamide molecules, each polyamide molecule having many (more than 10, 100, or 1000, etc.) instances of one or more amide monomers, where the amide monomers of the polyamide molecules of the mixture make up most or all of each polyamide molecule by weight (for example greater than 80, 90, 95, or 99% with any remainder due to minor other materials as end groups, non-amide monomers, or the like, or 100%). Exemplary amide monomers include various aliphatic polyamides such as nylon-6,6 (hexamethylene adipamide), nylon-4, nylon-6, nylon-12, nylon-11, nylon-10, and the like, singly or in combination, and various partially aromatic polyamides such as hexamethylene terephthalamide, hexamethylene isophthalamide, tetramethylene terephthalamide, 2-methyl pentamethylene terephthalamide, p-phenylene terephthalamide, and m-phenylene adipamide, m-xylylene adipamide, dodecamethylene terephthalamide, dodecamethylene isophthalamide, decamethylene terephthalamide, decamethylene isophthalamide, nonamethylene terephthalamide, nonamethylene isophthalamide, 2-methylpentamethylene isophthalamide, caprolactam-hexamethylene terephthalamide, and caprolactam-hexamethylene isophthalamide, individually or in combinations thereof.

As used herein, the terms “partially aromatic polyamide” (“PAP”) and “semiaromatic polyamide” are interchangeable and refer to a polyamide derived in part from one or more aromatic dicarboxylic acids, where the total aromatic dicarboxylic acid is at least 50 mole percent, preferably at least 80 mole percent and more preferably essentially all of the dicarboxylic acid(s) from which the polyamide is derived. Preferred aromatic dicarboxylic acids are terephthalic acid and isophthalic acid, and their combinations.

As used herein, the term “aliphatic polyamide” (“AP”) is a polyamide derived from one or more aliphatic diamines and one or more dicarboxylic acids, and/or one or more aliphatic lactams, provided that of the total dicarboxylic acid derived units present less than 60 mole percent, more preferably less than 20 mole percent, and especially preferably essentially no units derived from aromatic dicarboxylic acids are present.

As used herein, the term “aliphatic diamine” is a compound in which each of the amino groups is bound to an aliphatic carbon atom. Useful aliphatic diamines include diamines of the formula H₂N(CH₂)ₙNH₂ wherein n is 4 through 12, and 2-methyl-1,5-pentanediamine.

As used herein, the term “aromatic dicarboxylic acid” is a compound in which each of the carboxyl groups is bound to a carbon atom which is part of an aromatic ring. Useful dicarboxylic acids include terephthalic acid, isophthalic acid, 4,4′-biphenyldicarboxylic acid, and 2,6-naphthalenedicarboxylic acid.

As used herein, the phrase “coating said thermoplastic with a metal” means a conventional process for metal coating a thermoplastic, such as electroless coating, electrolytic plating, vacuum metallization, various sputtering methods, and lamination of metal foils. The process of coating may be a simple one step coating process wherein the metal is “applied” to the TP, but it may also include other steps, such as surface preparation, application of catalyst, or application of adhesives. Multiple layers of metals may be applied, consisting of the same or different compositions.

As used herein, the term “extractable component” is defined as an inorganic or organic ingredient present in a TP composition which is at least partially removed and/or whose surface is altered by appropriate treatment, under conditions which do not significantly deleteriously affect the TP. Such conditions include acid, base, thermal, or solvent, or other. The extractable component is removed, partially or completely, from the surface of the polymeric article made of the TP composition by the treatment applied. For example, the extractable component may be material such as calcium carbonate or zinc oxide or various clays, ceramics, or their combinations, and/or one or more various rubbers, which can be removed (etched) by aqueous hydrochloric acid, or a material such as zinc oxide or citric acid which may be removed by aqueous base, or materials such as poly(methyl methacrylate) which can be de polymerized and removed at high temperatures, or citric acid or sodium chloride which can be removed by a solvent such as water. Since the TP will normally not be greatly affected by the treatment, usually only the extractable component near the surface of the article will be affected, being either partially or completely removed. It is thus beneficial to have the surface enriched in the extractable component.

The materials used as extractable components are determined by the conditions used for the etching, including the etchant (thermal, solvent, or chemical), and the physical conditions under which the etching is carried out. For example, for any particular TP composition, etching should not be carried out at a temperature high enough to cause extensive thermal degradation of the TP, and/or the TP should not be exposed to a chemical agent which extensively attacks the TP, and/or to a solvent which readily dissolves the TP. Some compromise or damage to the TP may be acceptable, and indeed a small amount of etching of the TP surface itself due to “attack” on the TP itself may be useful in improving adhesion to the metal coating and the coating process of choice.

Preferred extractable components are alkaline earth (Group 2 elements, IUPAC Notation) carbonates, and calcium carbonate is especially preferred. Preferably the minimum amount of extractable components is 0.5 weight percent or more, more preferably about 1.0 weight percent or more, very preferably about 2.0 weight percent or more, and especially preferably about 5.0 weight percent or more. The preferred maximum amount of extractable components present is about 30 weight percent or less, more preferably about 15 weight percent or less, and especially preferably about 10 weight percent or less. In one embodiment, the extractable component at the surface region of an article is present in an amount of at least 101% by weight, compared to the amount present in the total composition of the article. These weight percents are based on the total TP composition. It is to be understood that any of these minimum weight percents can be combined with any of the maximum weight percents to form a preferred weight range for extractable components. More than one extractable component may be present, and if more than one is present the amount of extractable components is taken as the total of those present.

As used herein, the term “anchoring sites” means the cavities left in the surface of the article made of a TP composition from the removal or partial removal of the extractable. The anchoring sites are typically of the shape of the removed extractable or the removed portion of the extractable. For example, they can be spherical or near spherical, or irregularly shaped, or elongated, and may have roughness/partial roughness or they may be smooth/partially smooth. The anchoring sites are typically of the size of the part of the extractable that was removed. In one embodiment, the anchoring sites range in diameter from about 0.1 microns to about 20 microns in at least 2 dimensions. In another embodiment, the anchoring sites range in diameter from about 0.1 microns to about 10 microns in at least 2 dimensions. A greater number of such anchoring sites results in higher peel strength between the TP article and the metal coating, therefore it is beneficial to have a greater concentration of extractable on the surface of the article.

TPs that are useful in the present invention include poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon 4, nylon-6, nylon-10, nylon-12, nylon-11, and partially aromatic (co)polyamides; liquid crystalline polymers, such as polyesters and polyester-amides; polyolefins, such as polyethylene (including all forms such as low density, linear low density, or high density), polypropylene, polystyrene, polystyrene/poly(phenylene oxide) blends, polycarbonates, such as poly(bisphenol-A carbonate); acrylonitrile butadiene styrene; fluoropolymers, including perfluoropolymers, and partially fluorinated polymers, such as copolymers of tetrafluoroethylene and hexafluoropropylene, poly(vinyl fluoride), and the copolymers of ethylene and vinylidene fluoride or vinyl fluoride; polysulfones such as poly(p-phenylene sulfone), polysulfides such as poly(p-phenylene sulfide); polyetherketones, such as poly(ether-ketones), poly(ether-ether-ketones), and poly(ether-ketone-ketones); poly(etherimides); acrylonitrile-1,3-butandinene-styrene copolymers; thermoplastic (meth)acrylic polymers such as poly(methyl methacrylate); and chlorinated polymers, such as poly(vinyl chloride), vinyl chloride copolymer, and poly(vinylidene chloride).

Also included are thermoplastic elastomers, such as thermoplastic polyurethanes, block-copolyesters containing soft blocks, such as polyethers and hard crystalline blocks, and block copolymers, such as styrene-butadiene-styrene and styrene-ethylene/butadiene-styrene block copolymers. In addition, blends of thermoplastic polymers, including blends of two or more semicrystalline or amorphous polymers, or blends containing both semicrystalline and amorphous thermoplastics are also included herein.

Semicrystalline TPs are preferred, and include polymers such as poly(oxymethylene) and its copolymers; polyesters such as poly(ethylene terephthalate), poly(1,4-butylene terephthalate), poly(1,4-cyclohexyldimethylene terephthalate), and poly(1,3-poropyleneterephthalate); polyamides, such as nylon-6,6, nylon-6, nylon-10, nylon-11, nylon-12, combinations thereof, and partially aromatic (co)polyamides; liquid crystalline polymers, such as polyesters and polyester-amides; polyolefins, such as polyethylene (all forms such as low density, linear low density, and high density), polypropylene, fluoropolymers, including perfluoropolymers, and partially fluorinated polymers, such as copolymers of tetrafluoroethylene and hexafluoropropylene, poly(vinyl fluoride), and the copolymers of ethylene and vinylidene fluoride, or vinyl fluoride; polysulfones, such as poly(p-phenylene sulfone), polysulfides, such as poly(p-phenylene sulfide); polyetherketones, such as poly(ether-ketones), poly(ether-ether-ketones), and poly(ether-ketone-ketones); and poly(vinylidene chloride). Also included are thermoplastic elastomers, such as thermoplastic polyurethanes, block-copolyesters containing soft blocks, such as polyethers, hard crystalline blocks, and block copolymers, such as styrene-butadiene-styrene and styrene-ethylene/butadiene-styrene block copolymers.

In the present invention, TPs have a Tg and/or Tm of about 50° C. or more, preferably about 80° C. or more, and more preferably about 120° C. or more. In a preferred embodiment, the TP is at least 30 weight percent of the total composition. It is to be understood that more than one TP may be present in the composition, and the amount of TP present is taken as the total amount of TP(s) present.

As used herein the term “fillers” means filler or reinforcement, and it may be any reinforcing fiber, such as carbon fiber, carbon nanotubes, aramid fiber, or glass fiber, and it can have various shapes such as short, chopped, or long, or continuous fiber, spherical, platelet, or other. In a preferred embodiment of the invention, the fiber is synthetic, more preferred is glass fiber, and most preferred is chopped glass fiber with a maximum average length of about 1 mm to about 20 mm, more preferably about 2 mm to about 20 mm. In a preferred embodiment, the largest cross sectional dimension of the fiber is less than about 20 μm. The fiber can have a round diameter or it can be flat, and it may be coated with one or more substances to promote adhesion to the TP matrix or they may be uncoated.

As used herein, the term “flat reinforcing fiber” (“FRF”) is a fiber that has a noncircular cross section. Preferably the aspect ratio of the cross section is about 1.5 or more, more preferably about 2.0 or more. The cross section may be any shape except circular, and includes, but is not limited to, elliptical, oval, rectangular, or triangular.

In one embodiment, the filler present in the TP composition used in the articles of the present invention is a minimum of at least about 5 weight percent, preferably at least about 10 weight percent, and more preferably at least about 20 weight percent, based on the total composition. In another embodiment, the filler is 70 weight percent or less, preferably 50 weight percent or less, and more preferably 40 weight percent or less of the total composition. It is to be understood that any preferred minimum concentration may be combined with any preferred maximum concentration for a preferred concentration range for the FRF, and that more than one filler may be present in the TP composition.

Other ingredients may optionally be present in the TP composition in the articles of the present invention. These include other ingredients typically found in TP compositions, such as tougheners, pigments, coloring agents, stabilizers, antioxidants, lubricants, flame retardants, and adhesion promotion agents.

The TP compositions may be made by those methods which are used in the art to make TP compositions in general, and are well known. Most commonly the TP itself will be melt mixed with the various ingredients in a suitable apparatus, such as a single or twin screw extruder or a kneader. In order to prevent extensive degradation of the reinforcing fiber length it may be preferable to side feed the fiber. A twin screw extruder may be used for this purpose, so the fiber is not exposed to the high shear of the entire length of the extruder.

Uncoated articles of manufacture may be formed by conventional methods for producing TP compositions, such as injection molding, extrusion, blow molding, thermoforming, and rotomolding, etc. A preferred method is injection molding, wherein the TP composition is melted by an injection molding extruder so that it achieves a certain melt temperature when it exits the molding extruder. This melt temperature is typically above the melting point of the TP. The molten TP is injected into a mold cavity, the mold having a set temperature below the TP's melting point, wherein the TP cools. In a preferred embodiment, the melt temperature is about 200° C. to 360° C. In a more preferred embodiment of the invention, the melt temperature is about 260° C. to 345° C.

As used herein, “melt temperature” is the temperature of the molten TP composition as it exits the injection molding extruder. Melt temperature may be at least 5° C., 10° C., 20° C., or 50° C. above the Tm of the TP composition but below the temperature leading to the onset of degradation of the TP. The preferred temperature is at least 20° C. above the Tm. In a preferred embodiment, the mold temperature is about 40° C. to 150° C. If more than one TP is present in the composition, the highest Tm is taken as the reference Tm.

As used herein, “mold temperature” means the set temperature of the mold that the molten TP composition is injected into. Mold temperature may be at least 10° C. below the Tm of the TP composition. In a preferred embodiment, the mold temperature is at least 200° C. below the Tm or lower than about 20° C. above the Tg of the TP composition. The preferred range of the mold temperature is from about 40° C. to about 180° C. If more than one TP is present in the composition, the highest Tg is taken as the reference Tg. In one embodiment, at least 50% of the surface region of the molded article has a thickness of at least 0.1 μm.

Useful coating methods include electrolytic and electroless coating. The metal coatings can comprise at least one metal in elemental form, alloys of such metals, metal matrix composites, or combinations thereof. The coatings can be more than 0.01 μm, 5 μm, 10 μm, 25 μm, or 50 μm thick, while less than 0.1 cm, 1 cm, or 10 cm thick.

In a typical metal plating of a plastic material, such as a thermoplastic PAP, the surface of the PAP is cleaned and then surface treated. Alternatively, these two steps may be combined, or performed simultaneously. This surface treatment is typically done by using an acidic material such as sulfochromic acid and/or another acidic material, such as hydrochloric acid or sulfuric acid. Then the surface is treated with a catalyst, typically a palladium compound, followed by the electroless plating solution, which deposits a layer of metal such as nickel or copper onto the surface of the PAP. This may be the end of the process, or if a thicker and/or different metal layer is desired, the surface may be electroplated in the usual manner. For example, in one embodiment the first metal layer comprises at least one metal, metal alloy, metal matrix composition, or combination thereof, and a second layer comprises at least one metal, metal alloy, metal matrix composition, or combination thereof. If the PAP composition is electrically conductive then electroless plating may not be needed, and only the electroplating is done.

Any metal that may be electroplated may be used in the composition of the articles of the present invention. Useful metals include copper, nickel, cobalt, iron, and zinc. Alloys of these metals, such as nickel-iron may also be plated. The resulting electroplated metal layer may have an average metal grain (crystallite) size in the range of 1 to 10,000 nm. A preferred average grain size is 1 to 200 nm, more preferably 1 to 100 nm. The total thickness of the coated metals is preferably about 1 to about 200 μm, more preferably about 1 to about 100 μm. In one embodiment, the first layer is at least about 0.1 μm to 5 μm thick, and a second layer is at least about 10 μm to 200 μm thick.

Articles made in accordance with the invention may be composite articles, metal coated composite articles, or articles adapted to form at least a portion of electronic devices such as: cell phones, personal digital assistants, music storage devices, listening devices, portable video players, electrical multimeters, mobile electronic game consoles, or mobile personal computers.

When ranges are used herein for physical properties, such as molecular weight, or chemical properties, such as chemical formulae, all combinations, and subcombinations of ranges for specific embodiments therein are intended to be included.

### Examples

The present invention is further defined in the following examples. It should be understood that these examples, while indicating preferred embodiments of the invention are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Composition 1

Composition 1 was composed of 49.05 parts polyamide 6,6 made of 1,6-diaminohexane and 1,6-hexanedioic acid; 0.40 parts Chimassorb 944, also known as poly[(6-[(1,1,3,3-tetramethylbuty)amino]-1,3,5-triazine-2,4-diyl][(2,2,6,6-tetramethyl-4-piperidinyl)imino]-1,6-hexanediyl[2,2,6,6-tetramethyl-4-piperidinyl)imino]]); 0.20 parts Irganox 1098, also known as 3,3′-bis(3,5-di-tert-butyl-4-hydroxyphenyl)-N,N′-hexamethylenedipropionamide; 0.25 parts LICOMONT® CAV 102, a calcium salt of montanic acid crystallization promoter available from Clariant GmbH, Augsburg, Germany; 10 parts SUPER-PFLEX 200, a surface-treated, fine particle size, precipitated calcium carbonate with narrow particle size distribution available from Specialty Minerals, Inc., Bethlehem, Pa., having a typical 2% stearic acid surface treatment, average particle size 0.7 microns, +325 mesh residue of 0.03 weight percent, and surface area of 7 meters/gram; 40 parts glass fibers, namely PPG 3540 of nominal length 3.2 mm, available from PPG Industries, Pittsburgh, Pa.

Pellets of the composition 1 were prepared by melt blending the components in order as shown in an extruder, where the glass was fed into the molten polymer matrix with a side feeder. Pelletizing temperature was from about 310° C. to 330° C. Upon exiting the strand die, they were quenched in water and pelletized. The pellets were approximately 3 mm in diameter and 5 mm in length. Composition 1 had a Tm of 263.5° C. and a Tg of 50.9° C. The prepared pelletized composition was then dried at 100° C. for 6-8 hours in dehumidified dryer and then molded into a standard ISO 294 type D2 plaque of 6 cm×6 cm×2 mm, at a melt temperature of about 280° C. to 310° C., and a mold temperature of about 100° C. to 130° C.

### Compositions 2 and 3

Compositions 2 and 3 were composed of 34.15 parts polyamide 6,6 (PA66) made of 1,6-diaminohexane and 1,6-hexanedioic acid; 15 parts amorphous polyamide composed of 1,6-diaminohexane, 70 mole percent isophthalic acid and 30 mole percent terephthalic acid (mole percents based on total amount of dicarboxylic acids present in polyamide B); 0.40 parts Chimassorb 944 also known as poly[(6-[(1,1,3,3-tetramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]); 0.20 parts Irganox 1098, also known as 3,3′-bis(3,5-di-tert-butyl-4-hydroxyphenyl)-N,N′-hexamethylenedipropionamide; 0.25 parts LICOMONT® CAV 102; 10 parts SUPER-PFLEX 200; and 40 parts glass fibers, namely PPG 3540 of nominal length 3.2 mm, available from PPG Industries, Pittsburgh, Pa., in the case of composition 2, or flat glass fibers, namely NITTOBO CSG3PA-820, 3 mm long, 2 microns wide, 7 microns thick, aspect ratio of cross-sectional axes of 4, having aminosilane sizing, from NITTO BOSEKI, Japan, in the case of composition 3.

Pellets of compositions 2 and 3 were prepared by melt blending the components similarly as in composition 1 with a pelletizing temperature of about 280° C. to about 310° C. Compositions 2 and 3 had a Tm of 260.5° C. and a Tg of 88.3° C. Plaques were similarly prepared from the pellets at a melt temperature of about 270° C. to about 305° C., and a mold temperature of about 70° C. to 110° C.

### Composition 4

Composition 4 was composed of 47.35 parts polyamide made from terephthalic acid, 50 mole percent (of the total diamine present) of 1,6-hexanediamine, and remaining 50 mole percent of 2-methyl-1,5-pentanediamine; 2 parts polyamide 6,6 made of 1,6-diaminohexane and 1,6-hexanedioic acid; 0.40 parts of HS triblend 7:1:1; 0.25 parts Licowax OP; 10 parts SUPER-PFLEX 200; and 40 parts glass fibers, namely PPG 3660 of nominal length 3.2 mm, available from PPG Industries, Pittsburgh, Pa.

Pellets of the composition 4 were prepared by melt blending, as in composition 1. The pelletizing temperature was from about 330° C. to 345° C. Composition 4 had a Tm of 302.4° C. and a Tg of 132.9° C. Plaque specimen were analogously prepared at a melt temperature from about 320° C. to 345° C., and a mold temperature from about 140° C. to 160° C.

### Composition 5

Composition 5 was composed of 49.15 parts polyamide 6, made of caprolactam and 1,6-hexanedioic acid; 0.40 parts Chimassorb 944; 0.20 parts Irganox 1098; 0.25 parts LICOMONT® CAV 102; 10 parts SUPER-PFLEX 200; and 40 parts PPG 3540 glass fibers. Pellets of composition 5 were prepared by melt blending, as in composition 1. The pelletizing temperature was from about 250° C. to 280° C. Composition 5 had a Tm of 220.2° C. and a Tg of 57.1° C. Plaque specimen were analogously prepared at a melt temperature of about 250° C. to 280° C., and a mold temperature of about 60° C. to 100° C.

### Composition 6

Composition 6 was composed of 80 parts polyamide 6,6 made of 1,6-diaminohexane and 1,6-hexanedioic acid; 0.40 parts Chimassorb 944, also known as poly[(6-[(1,1,3,3-tetramethylbutyl)amino]-1,3,5-triazine-2,4-diyl][(2,2,6,6-tetramethyl-4-piperidinyl)imino]-1,6-hexanediyl[2,2,6,6-tetramethyl-4-piperidinyl)imino]]); and 20 parts SUPER-PFLEX 200, a surface-treated, fine particle size, precipitated calcium carbonate with narrow particle size distribution available from Specialty Minerals, Inc., Bethlehem, Pa., having a typical 2% stearic acid surface treatment, average particle size 0.7 microns, +325 mesh residue of 0.03 weight percent, and surface area of 7 meters/gram.

Pellets of the composition 6 were prepared by melt blending, as in composition 1. Pelletizing temperature was from about 310° C. to 330° C. Composition 6 had a Tm of 263.5° C. and a Tg of 50.9° C. Plaque specimen were analogously prepared at a melt temperature from about 280° C. to 310° C., and a mold temperature of about 100° C. to 130° C.

The plaque was typically metalized by first etching in an acid solution, followed by activation with a solution comprising palladium ions, followed by acceleration with an aqueous solution of accelerator, followed by electroless nickel plating, followed by a galvanic copper plating of about a 20 micron thickness of metallic copper from aqueous copper sulphate. Compositions 1, 2, 3, 5, and 6 were metalized as shown in Table 2, and composition 4 was metalized as shown in Table 3.

The peel strength of the copper from the plated plaques from the compositions was measured by a Z005 tensile tester (Zwick USA LP, Atlanta, Ga.) with a load cell of 2.5 kN using ISO test method 34-1. An electroplated plaque was fixed on a sliding table which was attached to one end of the tensile tester. Two parallel cuts, 1 cm apart, were made into the metal surface so that a band of metal on the surface 1 cm wide was created. The table slid in a direction parallel to the cuts. The 1 cm wide copper strip was attached to the other end of the machine, and the metal strip was peeled (at a right angle) at a test speed of 50 mm/min (temperature 23° C. and 50% relative humidity). The peel strengths of each example are shown in Table 1.

TABLE 1

| | comparative | | | examples | | |
|---|---|---|---|---|---|---|
| | molding conditions | | | molding conditions | | |
| | melt temp | mold temp | peel strength | melt temp | mold temp | peel strength |
| | (C.) | (C.) | (N/cm) | (C.) | (C.) | (N/cm) |
| Composition 1 | 280 | 115 | 8.6 | 310 | 100 | 18.7 |
| Composition 2 | 279 | 100 | 11.1 | 295 | 100 | 17.1 |
| Composition 3 | 282 | 100 | 5.9 | 290 | 80 | 24.3 |
| Composition 4 | 310 | 150 | 4.0 | 342 | 140 | 8.8 |
| Composition 4 | 323 | 180 | 3.8 | 325 | 144 | 8.0 |
| Composition 5 | 260 | 100 | 18.2 | 270 | 70 | 22.2 |
| Composition 6 | 280 | 130 | 16.9 | 310 | 100 | 20.2 |
| | | | Inhomogeneous | | | homogeneous |

TABLE 2

| | Bath | | | | |
|---|---|---|---|---|---|
| Step | Purpose | Additives | Stirring | ° C. | Minutes |
| 1 | Etching | PM847^{a} | mechanical | 35-50 | 5-20 |
| 2 | Rinse | De-ionized H2O | no | Ambient | 2 |
| 3 | Rinse | De-ionized H2O | ultrasonic | Ambient | 5-15 |
| 4 | Rinse | De-ionized H2O | no | Ambient | 1 |
| 5 | Activator | PM 857 (150 ppm | mechanical | 30 | 5-10 |
| | | Pd) | | | |
| 6 | Rinse | De-ionized H2O | no | Ambient | 2 |
| 7 | Acceler- | PM867 | mechanical | 30 | 1-3 |
| | ator | | | | |
| 8 | Rinse | De-ionized H2O | no | Ambient | 1 |
| 9 | Chemical | PM980 R&S | pump | 45 | 10-30 |
| | Ni | | | | |
| 10 | Rinse | De-ionized H2O | no | Ambient | 1 |
| 11 | Galvanic | CuSO4 | mechanical/ | Ambient | 40 |
| | Cu | | air | | |
| 12 | Rinse | De-ionized H2O | no | Ambient | 1 |

^{a}Aqueous solution additives marked “PM” are from Rohm & Haas.

TABLE 3

| | | | | Time, |
|---|---|---|---|---|
| Step No. | Bath Type | Additives | Temp. ° C. | min. |
| 1 | Etching | Sulfochromic acid | 50-80 | 5-20 |
| 2 | Rinse | De-ionized H2O | Ambient | 0.5 twice |
| 3 | Static Rinse | De-ionized H2O | Ambient | 1 |
| 4 | Rinse | De-ionized H2O | Ambient | 1 |
| 5 | Neutrali- | Neutraliser PM955^{b} | 55 | 2-5 |
| | zation | | | |
| 6 | Rinse | De-ionized H2O | Ambient | 1 |
| 7 | Pre-dip | 10% HCl (v/v) | Ambient | 0.5 |
| 8 | Activator | Conductron ® DP | 30 | 1-10 |
| | | (35 ppm Pd)^{b} | | |
| 9 | Rinse | De-ionized H2O | Ambient | 2 |
| 10 | Accelerator | Accelerator PM964^{b} | 45 | 2-10 |
| 11 | Rinse | De-ionized H2O | Ambient | 1 |
| 12 | Chemical Ni | PM 980 R&S^{b} | 30 | 10-30 |
| | PM | | | |
| 13 | Rinse | De-ionized H2O | Ambient | 1 |
| 14 | Galvanic Cu | CuSO₄ | Ambient | 40 |
| 15 | Rinse | De-ionized H2O | Ambient | 1 |

^{b}This material is available from Rohm & Haas Electronic Materials Europe, Coventry CV3 2RQ, Great Britain.

What is claimed:

1. A polymeric article having at least one surface region and comprising thermoplastic polymer, an extractable component, and, optionally, fillers, said surface region being relatively enhanced in said extractable component and relatively depleted in said fillers as compared to the article as a whole.

2. The article of claim 1, wherein at least 50% of said surface region has a thickness of at least 0.1 micrometers.

3. The article of claim 1 wherein said extractable component at the surface region is present in an amount of at least 101% by weight as compared to the amount present in the total composition of the article.

4. The article of claim 1, wherein said surface is etched.

5. The article of claim 5, wherein said surface contains anchoring sites.

6. The article of claim 5 wherein said anchoring sites have from about 0.1 microns to about 20 microns diameter in at least 2 dimensions.

7. The article of claim 1, wherein said optional fillers are glass fibers, carbon fibers, graphite, polymer, or combinations thereof.

8. The article of claim 1, wherein said thermoplastic polymer comprises one or more polyamides.

9. The article of claim 8, wherein said polyamide comprises poly(hexamethylene adipamide).

10. The article of claim 8, wherein said polyamide comprises poly(hexamethylene isophthalamide) or poly(hexamethylene terephthalamide) or combinations thereof.

11. The article of claim 1, wherein said extractable component is calcium carbonate.

12. The article of claim 1, comprising at least one metal coating or layer.

13. The article of claim 12, wherein a first metal layer comprises at least one metal, metal alloy, metal matrix composition, or combination thereof, and wherein a second metal layer comprises at least one metal, metal alloy, metal matrix composition, or combination thereof.

14. The article of claim 13, wherein said first layer is at least about 0.01 μm to 5.0 μm thick.

15. The article of claim 13, wherein said second layer is at least about 10 μm to 200 μm thick.

16. A method of making a polymeric article having at least one surface region and comprising thermoplastic polymer, an extractable component, and, optionally, fillers, said surface region being relatively enhanced in said extractable component and relatively depleted in said fillers as compared to the article as a whole, comprising:
melting said thermoplastic polymer and blending it with said extractable component and said fillers; and
injection molding said article at a melt temperature at least about 20° C. above the melting point of said thermoplastic polymer and at a mold temperature at least 200° C. below said melt temperature or less than about 20° C. above the glass transition temperature of said thermoplastic polymer.

17. The method of claim 16, wherein said melt temperature is about 200° C. to 360° C.

18. The method of claim 16, wherein said melt temperature is about 260° C. to 345° C.

19. The method of claim 16, wherein said mold temperature is about 40° C. to 150° C.

20. A composite article comprising the article of claim 1.

21. A composite article comprising the article of claim 12.

22. The article of claim 1 adapted to form at least a portion of an electronic device.

23. The article of claim 22 wherein said electronic device is a cell phone, personal digital assistant, music storage device, listening device, portable video player, electrical multimeter, mobile electronic game console, or mobile personal computer.
